(19) United States
(12) Patent Application Publication
(10) Pub. No.: US 2006/0056507 A1
(43) Pub. Date: Mar. 16, 2006

(54) Method and system for improving video/audio data display fluency

(76) Inventors: Jerry Chen, Hsinchu (TW); Loca Huang, Hsinchu (TW); Vincent Yen, Hsinchu (TW); Teng-Chou Chang, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/067,404

(22) Filed: Feb. 24, 2005

(30) Foreign Application Priority Data
Sep. 13, 2004 (TW) 93127654

(51) Int. Cl. H04N 11/04; H04N 11/02; H04N 7/12; H04B 1/66

(52) U.S. Cl. 375/240.01

(57) ABSTRACT

A method for improving fluency of video and audio data display includes a frame display time computation process, which calculates a best time interval according to a first GOP and utilizes the best time interval to display the frames in a second GOP after the first GOP. The method may further comprise a dynamic compensation process, which calculates a compensation time interval and utilizes it to display the frames in a third GOP after the second GOP to compensate the time error of the second GOP. Such steps will continue until the display of all GOPs has been performed or the operation has been stopped. The invention also disclosed a system for improving fluency of video and audio data display.

### BACKGROUND OF INVENTION

a) Field of the Invention

The invention relates to a method and system for improving video/audio data displaying fluency.

b) Description of the Related Art

In the field of video displaying technology, the time interval setting of original files is often wrong or has deviations because of different manufacturing sources regardless the format being AVI, MPEG1, MPEG2, or MPEG4. If the errors are not corrected, they will cause frames influency, which are uncomfortable to users while they are watching the frames in display. For example, in the video data of MPEG format, a time interval of 15 frames exists between the first frame of a GOP (group of pictures) and the first frame of a subsequent GOP but the frames therebetween are less than 15 frames. Thus inconsistent frame time intervals may occur, whereby the aforementioned fluency problem would happen if the data were displayed without being processed. FIG. 1 is a schematic diagram illustrating unprocessed group of pictures. Referring to FIG. 1, there is a plurality of frames 104 between start point 102 of a GOP 100 and start point 103 of another GOP 110, but time intervals 105, 106 and 107 therein between the frames 104 are of different lengths. A conventional way to solve the abovementioned problem is to create one to two buffer zones for storing frames, and when the frames stored therein are accumulated to a certain quantity, a new frame time interval is calculated. Other conventional methods include deleting frames with irregular time intervals so remaining frames have similar or synchronized time intervals, or inserting frames to achieve the effect of having similar time intervals. FIG. 2 is a schematic diagram illustrating time intervals fixed by using buffer zones. Referring to FIG. 2, the GOP 100 with different time intervals 105,106, and 107 is sent to a buffer zone 200 prior to being displayed, in which the plurality of frames 104 are rearranged. Consequently a same time interval 201 exists between each of the frames 104 of the GOP 100 output from the buffer zone 200.

Nonetheless, these methods will reset the frame times. In response, large-scale adjustments would be performed on each frame to meet the fluency requirement, and the creation and usage of buffer zones will also consume a lot of system resources and increase calculation load. In turn, these methods will have difficulty operating in lower-level systems and the usage of buffer zones will increase manufacturing cost. Moreover, in order to synchronize with audio signal, the time setting of audio encoding has to be controlled at the same time, which is more complex and takes up more resources, for example playing and recording video/audio data, or temporal translation recording. Furthermore, the variation of the frames arriving at output terminal and the consumption of the calculation load of the system program itself sometimes do not allow the buffer zone to occupy system recourses, especially when transmitting the video/audio data via wireless internet structures. Plus, video/audio editing often requires grabbing particular frames, if the buffer zone deletes frames, the accuracy of the data edited would be lacking, and these are inevitable problems.

Therefore, a novel method is needed to solve the aforementioned problems.

### SUMMARY OF THE INVENTION

An object of the invention is to provide a frame display time computation mechanism for improving the fluency of audio/video data display by providing a best time interval for displaying frames. The invention further provides a dynamic compensation mechanism for further improving the fluency of audio/video data display by providing a dynamic compensation to the frames in display.

Another object of the invention is to provide a system that does not require an advanced hardware to operate, and the system is able to keep the video/audio source of each frame to improve the fluency of the video/audio data display without increasing element quantity and hardware size.

To achieve the abovementioned objects, the invention provides a frame display time computation process, which computes a best time interval for displaying frames. The invention further calculates a dynamic time interval using a dynamic compensation process for compensating time error of frames in display.

Concluding from above, the invention provides a method for improving video/audio data displaying fluency comprising a frame display time computation process that computes a best time interval basing on an n-th GOP and uses the best time interval to display an (n+1)-th GOP subsequent to the n-th GOP.

The prescribed method for improving video/audio data displaying fluency further includes a dynamic compensation process for calculating a compensation time interval. The compensation time interval is used to display frames of an (n+2)-th GOP subsequent to the (n+1)-th GOP to compensate a time error in the (n+1)-th GOP.

Then, similar steps continue to be executed and the best time interval is re-selected until all the groups of pictures have been displayed.

The preferred method for computing the best time interval basing on the n-th GOP is to calculate a predicted time interval basing on the frames of the n-th group of pictures. The predicted time interval is then compared to a specific range; if the predicted time interval exceeds the specific range, a preset value is used as the best time interval, and if not, then the predicted time interval is used as the best time interval. The preferred method to calculate the predicted time interval basing on the frames of the n-th GOP is by calculating a time difference between the start points of the n-th GOP and the (n+1)-th GOP before dividing the time difference by number of frames in the n-th GOP to obtain the predicted time interval.

The aforementioned time error exists between the last frame of the (n+1)-th GOP and the start point of the (n+2)-th group of pictures. When this time error exceeds a predetermined error value, the dynamic compensation process is activated and the compensation time interval is used to display frames of the (n+2)-th GOP that are for compensating time errors. This compensation time interval is determined by the number of frames of the (n+2)-th GOP that are for compensating time errors.

Another embodiment of the invention is a system for improving audio/video data displaying fluency. The system includes a displaying module, a frame display time computation module, and a dynamic compensation module. The displaying module is connected to a display screen and is used to display a plurality of groups of pictures. The frame display time computation module is connected to the displaying module and computes a best time interval basing on an n-th GOP from the prescribed groups of pictures. The best time interval value is then transmitted to the displaying module for displaying frames of an (n+1)-the GOP subsequent to the n-th group of pictures. The dynamic compensation module is connected to the displaying module and calculates a compensation time interval. The compensation time interval value is then transmitted to the displaying module for displaying frames of an (n+2) GOP subsequent to the (n+1)-th GOP to compensate a time error of the (n+1)-th group of pictures.

The best time interval computed basing on the n-th GOP as aforementioned refers to using the frames of the n-th GOP to calculate a predicted time interval. When the predicted time interval exceeds a specific range, a preset value is used as the best time interval; if not, the predicted time interval is used as the best time interval. The predicted time interval calculated using the frames of the n-th GOP refers to calculating a time difference between the start points of the n-th and the (n+1)-th GOP and dividing this time difference by the number of frames in the n-th GOP in order to obtain the predicted time interval.

The time error as prescribed exists between the last frame of the (n+1)-th GOP and the start point of the (n+2)-th group of pictures. The displaying module uses the compensation time interval to display the frames of the (n+2)-th GOP that are for compensating time errors when the time error exceeds a predetermined error value. The number of frames in the (n+2)-th GOP that are for compensating time errors is a deciding factor in determining the compensation time interval.

As described above, the displaying module continues to execute similar steps and the best time interval is re-selected until all of the groups of pictures have been displayed.

In conclusion, the method and system for improving audio/video data displaying fluency according to the invention not only improves the fluency of displaying frames, it further uses dynamic compensation to recover the time errors in the groups of pictures, and thus improves the video/audio data display fluency without adding other elements or deleting frames.

### BRIEF DESCRIPTION OF THE DRAWINGS

FIG. 1 is a schematic diagram illustrating unprocessed groups of pictures.

FIG. 2 is a schematic diagram illustrating a conventional method for compensating video display using buffer zones.

FIG. 3a is a schematic diagram illustrating unprocessed groups of pictures.

FIG. 3b is a schematic diagram illustrating groups of pictures that have been processed by frame display time computation process; the frame display time computation process is a preferred embodiment of a method for improving video/audio data display fluency according to the invention.

FIG. 3c is a schematic diagram illustrating groups of pictures that have been processed by dynamic compensation process; the dynamic compensation process is according to a preferred embodiment of the method for improving video/audio data display fluency according to the invention.

FIG. 4 is a flow chart illustrating a preferred embodiment of the method for improving video/audio data display fluency according to the invention.

FIG. 5 is a block diagram illustrating a preferred embodiment of a system for improving video/audio data display fluency according to the invention.

FIG. 6 is a schematic diagram illustrating groups of pictures that have been processed by the method for improving video/audio data display fluency according to the invention.

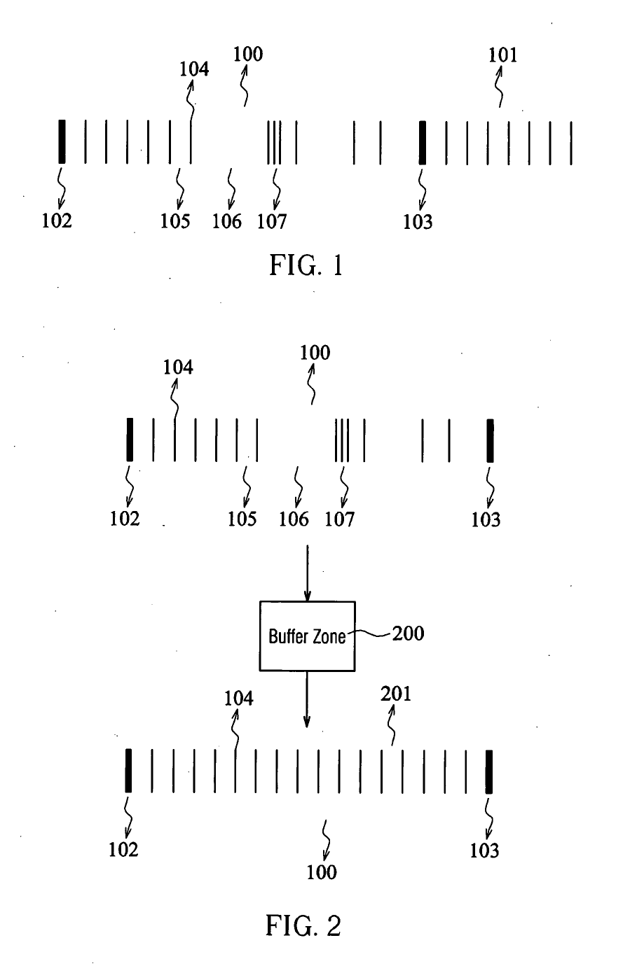

### DETAILED DESCRIPTION OF THE INVENTION

The method for improving video/audio data displaying fluency according to the invention will be described in detail with aiding figures.

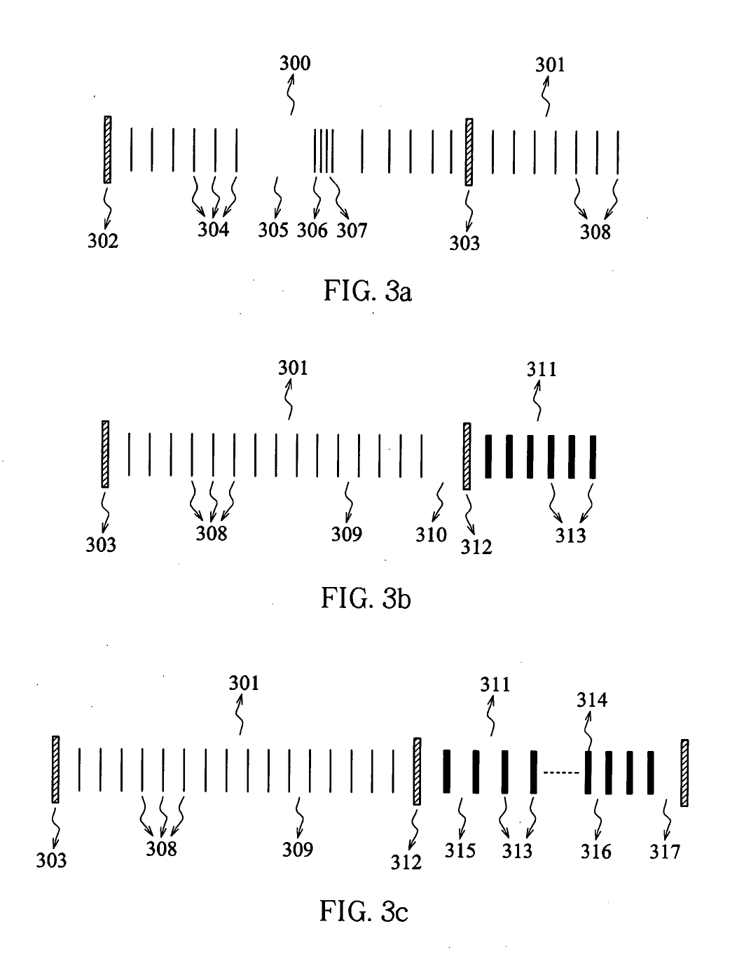

FIG. 3a illustrates unprocessed groups of pictures. As shown in FIG. 3a, an n-th GOP 300 comprises an I frame 302 as start point and a plurality of frames 304 in P frame or B frame formats. Often time intervals existed between each frame 104 are of different lengths, for example time intervals 305, 306, and 307, and as aforementioned, these different time intervals are a main cause to lack of fluency in frame displaying. Also shown in FIG. 3a is an (n+1)-th GOP 301 comprising an I frame 303 as start point and a plurality of fra+mes 308 in P frame or B frame formats.

The frames are then processed by a frame display time computation process according to a preferred embodiment of the invention. The frame display time computation process computes a best time interval (Tb) for displaying frames, the steps are: calculating a time difference (Tint) between I frame 302 and I frame 303, then dividing the time difference (Tint) by the number of frames 304 to obtain a predicted time interval (Td). This predicted time interval (Td) cannot be used directly to display the subsequent (n+1)-th GOP 301 because if the error is too great in the video data itself, the predicted time interval (Td) calculated may exceed a time interval range that maintains frame fluency. Thus further assessment is needed to decide whether the predicted time interval (Td) could be the best time interval (Tb) for displaying the frames 308 of (n+1)-th GOP 301. Moreover, in the preferred embodiment of the invention, the best time interval of each GOP is calculated continuously for displaying subsequent frames; this act will be described.

According to the experiment result, when the predicted time interval is between a multiple of δ_{low} and δ_{high} of NTSC (National Television System Committee) standard value, users do not feel uncomfortable in regards to discontinuation-of video images, wherein δ_{low} is between 0.1 and 1, and 6 high is between 1 and 1.9; the standard value of NTSC is 29.97 frames per second. Similarly, when the predicted time interval is between a multiple of δ_{low} and δ_{high} of PAL (Phase Alternating Line, used in Europe) standard value, users do not feel uncomfortable in regards to discontinuation of video images, wherein δ_{low} is between 0.1 and 1, and 67 _{high} is between 1 and 1.9; the standard value of NTSC is 25 frames per second. Thus, if the predicted time interval (Td) falls in the abovementioned range, it is used as the best time interval (Tb), and if not, the NTSC standard value or PAL standard value is used as the best time interval (Tb). Then, the frames 308 are displayed according to the best time interval.

The (n+1)-th GOP 301 that has been processed by the frame display time computation process is shown in FIG. 3b. There is a same time interval 309 between each of the frames 308 where the time interval 309 is the best time interval (Tb) as previously described; thus the frame displaying fluency is significantly improved. Since the time interval 309 is computed basing on the n-th GOP 300, there may be a time error 310 between the last frame 308 of the (n+1)-th GOP 301 and I frame 312, the start point of (n+2)-th GOP 311, after all of the frames 308 has been displayed. When this time error 310 exceeds a predetermined error value, compensation is needed using a dynamic compensation process of the invention. The predetermined error value can be selected according to the video quality preferred, the smaller the predetermined error value is, the better the video quality is, but the changing rate of the frames is more frequent. On the other hand, if the predetermined error value is set larger, the video fluency is worse, but the changing rate of the frames is less frequent. According to the experiment result, a preferred value of the predetermined error value is a multiple of 0-120 of the best time interval (Tb).

A preferred embodiment of the dynamic compensation process as described above is to calculate a compensation time interval (Tn) for displaying a plurality of frames 313 of the (n+2)-th GOP 311 to compensate the time error 310. The length of the compensation time interval (Tn) depends on the number of frames 313 that are for compensating the time error 310. For example, if the length of time error 310 in FIG. 3b is double that of the best time interval (Tb) and 20 frames 313 are for compensating the timer error 310, each frame 313 is responsible for taking up one tenth of the best time interval (Tb) (2 divide by 20). Thus the time interval for the frames 313 is one best time interval (Tb) plus one tenth of the best time interval (Tb). Accordingly, if the number of frames for compensating the time error is 10, then the time interval for the frames 313 is one best time interval (Tb) plus two tenths (2 divide by 10) of the best time interval (Tb). After the frames 313 for compensating time errors are displayed, the best time interval (Tb) is used to display remaining frames of the (n+2)-th GOP 311. It is to be noted that, though only one GOP is used to compensate time error in this embodiment, the invention allows the usage of a plurality of groups of pictures to compensate time error when the time error is of a great scale, so as to achieve the object of improving fluency.

FIG. 3c illustrates the (n+1)-th GOP 301 and the (n+2)-th GOP 311 after the dynamic compensation process has been performed. As shown in FIG. 3c, the (n+2)-th GOP 311 comprises the plurality of frames 313 for compensating time errors, a plurality of frames 314 not for compensating time errors, and the time error 310 that has been compensated using the dynamic compensation process; time interval 315 between frames 313 is the compensation time interval (Tn) calculated using the dynamic compensation process. As aforementioned, the time interval 315 is determined by the number of frames 313 for compensating the time error 310, and the length of the time interval 315 has to be within a range that doesn't affect the synchronization of users' sight and hearing. The preferred range is a multiple of 0-5 of time interval 309, which is a multiple of 0-5 of the best time interval (Tb). After the frames 313 have been displayed, the best time interval (Tb) is used as time interval 316 to continue displaying the frames 314 until all frames of the (n+2)-th GOP 311 has been displayed.

After all frames of the (n+2)-th GOP 311 has been displayed, continuously using dynamic compensation may cause too much variation to frames, and thus affects the accuracy of audio/video synchronization. Hence the prescribed best time interval is used to display (n+3)-th GOP (not illustrated), and after displaying, the prescribed assessing method and dynamic compensation process are used to compensate time error generated from the (n+3)-th GOP.

Assuming that the number of GOP used to compensate the time error of (n+3)-th GOP is one, then the prescribed best time interval cannot be used to display (n+5)-th GOP, another best time interval must be recomputed to display the (n+5)-th GOP. This is because the number of frames in each GOP changes, therefore constantly using a same best time interval to display these frames is not suitable. As mentioned above, the best time interval of each GOP is computed continuously, so after a while, a predicted time interval of a GOP that is the closest and unused for dynamic compensation is selected to display subsequent group of pictures. This predicted time interval is applied in displaying the (n+5)-th GOP, then dynamic compensation is preformed, and the same actions are performed repeatedly.

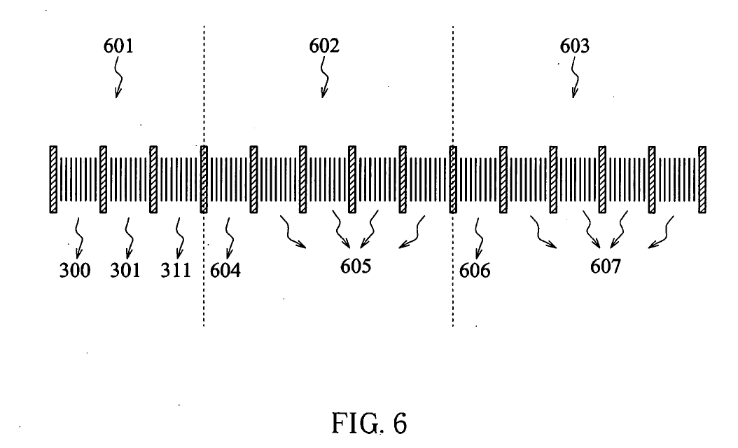

The actions described above are illustrated by FIG. 6. As shown in FIG. 6, a first set of groups of pictures 601 comprises the n-th GOP 300, (n+1)-th GOP 301, and (n+2)-th GOP 311 as prescribed; a second set of groups of pictures 602 comprises a (n+3)-th GOP 604 and an m number of groups of pictures 605; and a third set of groups of pictures 603 comprises an (n+4+m)-th GOP 606 and an x number of groups of pictures 607. As aforementioned, after computing a best time interval basing on the n-th GOP 300, the (n+1)-th GOP 301 is displayed using this best time, and then the (n+1)-th GOP 301 is compensated using the (n+2)-th GOP 311. Next, the best time interval is used to display the (n+3)-th GOP 604, and if necessary, the m number of groups of pictures 605 is used to compensate the (n+3)-th GOP 604. Afterwards, the best time interval computed basing on the (n+3)-th GOP 604 is used to display the (n+4+m)-th GOP 606, and if necessary, the x number of groups of pictures 607 is used to compensate the (n+4+m)-th GOP 606. Similar steps are carried out repeatedly until all of the groups of pictures have been displayed or the action has been stopped. The values of x and m are natural numbers and depend on the number of groups of pictures that are for compensating time errors.

It is to be noted that in FIG. 6, the assumption is that the dynamic compensation mechanism is activated whenever time error occurs. As described above, the first GOP of a new set of groups of pictures is displayed using a best time interval computed basing on the closest and uncompensated group of pictures. Thus in the example of FIG. 6, if the time error of (n+3)-th GOP 604 is not large enough to activate the dynamic compensation process, the (n+4)-th GOP is displayed using a best time interval computed basing on the (n+3)-th GOP 604. And if the time error of (n+4)-th GOP is too large and activated the dynamic compensation process, m number of groups of pictures is used to compensate the time error; and (n+5+m)-th GOP is then displayed using a best time interval computed basing on the (n+4)-th GOP. So on and so forth, the best time interval is renewed regularly to acquire the best video fluency.

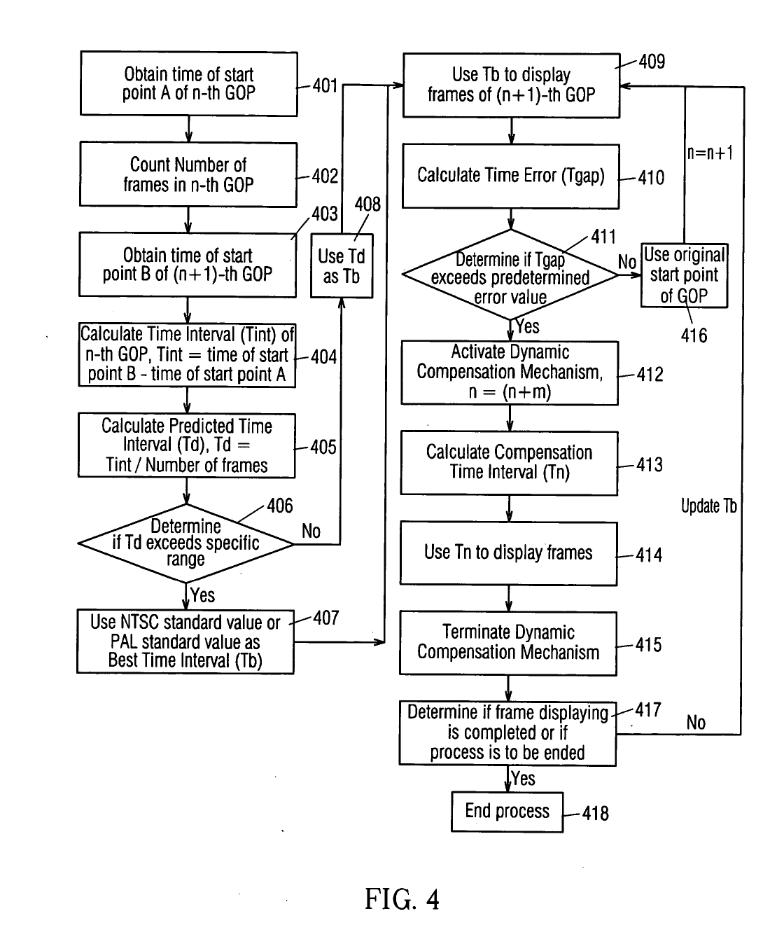

FIG. 4 is used to describe in detail a preferred embodiment of the method for improving video/audio data displaying fluency according to the invention. Referring to FIG. 4, in step 401, the time of start point A of n-th GOP is obtained, and in step 402, the number of frames in the n-th GOP is counted. In step 403, the time of start point B of (n+1)-th GOP subsequent to the n-th GOP is obtained. In step 404, a time interval (Tint) of n-th GOP is calculated, wherein Tint=Time of point B−Time of point A. In step 405, a predicted time interval (Td) is calculated, wherein Td=Tint/Number of frames.

Then proceed to step 406 to determine if Td exceeds the specific range. As aforementioned, Td must be between the multiple of δ_{low} to δ_{high} of NTSC standard value or the multiple of δ_{low} to δ_{high} of PAL standard value, so that displaying influency doesn't occur. If Td exceeds the specific range, proceed to step 407, where the NTSC standard value or the PAL standard value is used as the best time interval (Tb). Else, if Td falls within the specific range, proceed to step 408 where Td is used as Tb. Subsequently, step 408 and step 407 both lead to step 409, where Tb is used to display the frames of (n+1)-th GOP.

Since the Tb used is calculated from n-th GOP, a time error (Tgap) would occur in the (n+1)-th GOP. Thus proceed to step 410 for calculating the Tgap and to step 411 to determine if Tgap exceeds a predetermined error value. The predetermined error value is decided according to the picture quality required, the better the picture quality is required, the smaller the predetermined error value is set, and the preferred value of the predetermined error value is a multiple of 0-120 of Tb. If Tgap doesn't exceed the predetermined error value, the dynamic compensation process is not activated and step 416 is the next step in proceeding. In step 416, the original start point of GOP is used; this GOP refers to the (n+2)-th GOP subsequent to the (n+1)-th GOP. The process returns to step 409 after step 416 and the value of (n+1) replaces the value n; the sequence of step 409 to step 411 is then repeated.

Conversely, in step 411, if Tgap exceeds the predetermined error value, proceed to step 412 where the dynamic compensation mechanism is activated including deciding how many groups of pictures (assuming a number of m) and how many frames for compensating Tgap. Then proceed to step 413, where the original value n is replaced with a value (n+m) to calculate the compensation time interval (Tn) using prescribed method. The computation of Tn is described above and thus not further explained herein; the range of Tn is a multiple of 0-5 of Tb. In step 414, Tn is used to display frames that are for compensating Tgap. When all of the frames for compensating Tgap has been displayed, the dynamic compensation process is terminated in step 415. Next, proceed to step 417 to determine whether or not to end the process or if the displaying of all of the groups of pictures is complete. If yes, proceed to step 418 to end the process, if not, update Tb according to the prescribed rule and return to step 409.

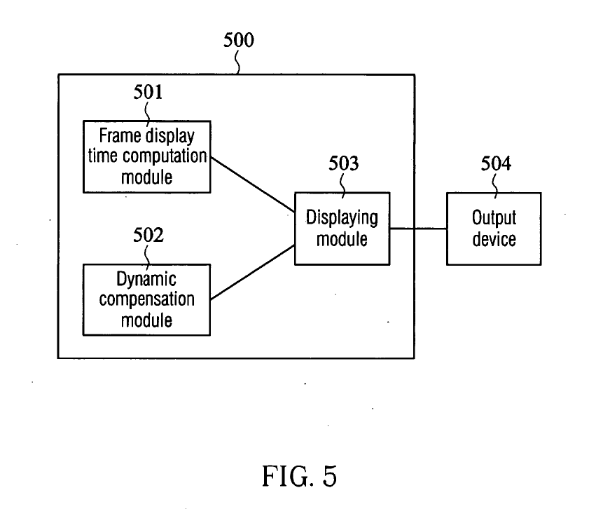

A system for improving audio/video data displaying fluency according to another embodiment of the invention is shown in FIG. 5. Referring to FIG. 5, the system for improving video/audio data displaying fluency 500 comprises a frame display time computation module 501, a dynamic compensation module 502, and a displaying module 503. The displaying module is connected to a display screen 504 for displaying groups of pictures and showing them on the display screen 504. The frame display time computation module 501 is connected to the displaying module 503 and computes a best time interval (Tb) basing on an n-th GOP of the groups of pictures mentioned above. The frame display time computation module 501 then transmits the value of best time interval (Tb) to the displaying module 503 for displaying frames of (n+1)-th GOP subsequent to the n-th GOP. The preferred calculation method of best time interval is to calculate a time difference between the start points of the n-th GOP and the (n+1)-th GOP, and then divide the time difference by the number of frames in the n-th GOP to obtain a predicted time interval (Tp) for displaying the frames. When the-predicted time interval (Tp) exceeds a specific range, a preset value is used as the best time interval, and if not, the predicted time interval (Tp) is used as the best time interval. Moreover, the frame display time computation module 501 computes the best time interval of every group of pictures.

The dynamic compensation module 502 is connected to the displaying module 503 and calculates a compensation time interval (Tn) before transmitting the value of the compensation time interval (Tn) to the displaying module 503. When a time error (Tgap) that exists between the last frame of (n+1)-th GOP and start point of (n+2)-th GOP exceeds a predetermined error value, the displaying module 503 uses the compensation time interval (Tn) to display time-error compensation frames of (n+2)-th GOP to compensate the time error (Tgap). The compensation time interval (Tn) is determined by the number of frames in the (n+2)-th groups of pictures that are for compensating time errors (Tgap).

The determination method of the value Tn, the meaning and the ranges of specific range, preset value, and predetermined error value are explained in detail in FIGS. 3a-3b and FIG. 4, and thus is not further described herein.

After the displaying module 503 has displayed the n-th to the (n+2)-th GOPs, an (n+3)-th GOP is displayed using best time interval computed basing on the n-th GOP as prescribed, and if necessary, an m number of groups of pictures is used to compensate the (n+3)-th GOP. Next, an (n+4+m)-th GOP is displayed using best time interval computed basing on the (n+3)-th GOP, and then if necessary, an x number of groups of pictures is used to compensate the (n+4+m)-th GOP. These steps are executed repeatedly until the groups of pictures have all been displayed or termination of the process is requested. The value of x or m is a natural number and depends on number of groups of pictures used to compensate time error.

According to the aforementioned method, the method for improving video/audio data displaying fluency of the invention not only provides best time interval for displaying frames, it also compensates frames in display. Hence improves the fluency of video/audio data display without changing encoding process of video/audio data. In addition, the system for improving video/audio data display fluency of the invention provides the frame display time computation module to improve time interval between frames, and the system further provides the dynamic compensation module to execute dynamic compensation to frames in display. Therefore the fluency of video/audio data display is improved without increasing element quantity and size.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for improving video/audio data displaying fluency, comprising:
a frame display time computation process for computing a best time interval basing on an n-th GOP and utilizing the best time interval to display frames of an (n+1)-th GOP subsequent to the n-th GOP, wherein n is a positive integer.

2. The method for improving video/audio data displaying fluency of claim 1, further comprising:
a dynamic compensation process for calculating a compensation time interval and utilizing the compensation interval to display frames of (n+2)-th GOP to (n+2+m)-th GOP subsequent to the (n+1)-th GOP to compensate a time error in the (n+1)-th GOP, wherein the dynamic compensation process is activated when the time error exceeds a predetermined error value, and m is a natural number.

3. The method for improving video/audio data displaying fluency of claim 2, further comprises displaying an (n+3+m)-th GOP using the best time interval, and compensating a time error of the (n+3+m)-th GOP using the dynamic compensation process and an x number of GOPs when the time error of the (n+3+m)-th GOP exceeds the predetermined error value, wherein x is a natural number.

4. The method for improving video/audio data displaying fluency of claim 3, further comprises displaying an (n+4+m+x)-th GOP using a best time interval computed basing on the (n+3+m)-th GOP, and compensating a time error of the (n+4+m+x)-th GOP using the dynamic compensation process and an y number of GOPs when the time error of the (n+4+m+x)-th GOP exceeds the predetermined error value, wherein y is a natural number.

5. The method for improving video/audio data displaying fluency of claim 1, wherein the computation of best time interval basing on the n-th GOP refers to using frames of the n-th GOP to calculate a predicted time interval; when the predicted time interval exceeds a specific range, a preset value is used as the best time interval, and if the predicted time interval doesn't exceed the specific range, the predicted time interval is used as the best time interval.

6. The method for improving video/audio data displaying fluency of claim 5, wherein the calculation of the predicted time interval using frames of n-th GOP refers to calculating a time difference between the start point of the n-th GOP and the start point of the (n+1)-th GOP before dividing the time difference by the number of frames in the n-th GOP to obtain the predicted time interval.

7. The method for improving video/audio data displaying fluency of claim 5, wherein the specific range is a multiple of 0.1-1.9 of NTSC standard value.

8. The method for improving video/audio data displaying fluency of claim 5, wherein the specific range is a multiple of 0.1-1.9 of PAL standard value.

9. The method for improving video/audio data displaying fluency of claim 2, wherein the time error exists between the last frame of the (n+1)-th GOP and the start point of the (n+2)-th GOP.

10. The method for improving video/audio data displaying fluency of claim 9, wherein the number of frames in the (n+2)-th GOP to the (n+2+m)-th GOP that are for compensating the time error determines the compensation time interval.

11. The method for improving video/audio data displaying fluency of claim 2, wherein the predetermined error value falls in a range of a multiple of 0-20 of the best time interval.

12. The method for improving video/audio data displaying fluency of claim 2, wherein the compensation time interval falls in a range of a multiple of 0-5 of the best time interval.

13. A method for improving video/audio data displaying fluency, comprising:
a frame display time computation process for computing a best time interval basing on an n-th GOP and utilizing the best time interval to display frames of an (n+1)-th GOP subsequent to the n-th GOP, the computation of the best time interval referring to calculating a time difference between the start points of the n-th GOP and the (n+1)-th GOP before dividing the time difference by the number of frames in the n-th GOP to obtain a predicted time interval for displaying the frames, when the predicted time interval exceeds a specific range, a predetermined value is used as the best time interval, and if the predicted time interval does not exceed the specific range, the predicted time interval is used as the best time interval; wherein n is a positive integer.

14. The method for improving video/audio data displaying fluency of claim 13, further comprising:
a dynamic compensation process for calculating a compensation time interval and utilizing the compensation time interval to display an (n+2)-th GOP to an (n+2+m)-th GOP subsequent to the (n+1)-th GOP to compensate a time error between the last frame of the (n+1)-th GOP and the start point of the (n+2)-th GOP, wherein m is a natural number of number of GOPs used to compensate the time error; when the time error exceeds a predetermined error value, the dynamic compensation process is activated, in which the number of frames in the (n+2)-th to (n+2+m)-th GOPs that are for compensating the time error determines the compensation time interval.

15. The method for improving video/audio data displaying fluency of claim 14, further comprises displaying an (n+3+m)-th GOP using the best time interval, and compensating a time error of the (n+3+m)-th GOP using the dynamic compensation process and an x number of GOPs when time error of the (n+3+m)-th GOP exceeds a predetermined error value, wherein x is a natural number.

16. The method for improving video/audio data displaying fluency of claim 15, further comprises displaying an (n+4+m)-th GOP using the best time interval of the (n+3+m)-th GOP, and compensating a time error of the (n+4+m)-th GOP using the dynamic compensation process and an y number of GOPs when the time error of the (n+4+m)-th GOP exceeds the predetermined error value, wherein y is a natural number.

17. The method for improving video/audio data displaying fluency of claim 13, wherein the specific range is a multiple of 0.1-1.9 of NTSC standard value.

18. The method for improving video/audio data displaying fluency of claim 13, wherein the specific range is a multiple of 0.1-1.9 of PAL standard value.

19. The method for improving video/audio data displaying fluency of claim 14, wherein the predetermined error value falls in a range of a multiple of 0-20 of the best time-interval.

20. The method for improving video/audio data displaying fluency of claim 14, wherein the compensation time interval falls in a range of a multiple of 0-5 of the best time interval.

21. A system for improving video/audio data displaying fluency, comprising:
a displaying module connected to a display screen for displaying a plurality of GOPs;
a frame display time computation module connected to the displaying module for computing a best time interval basing on an n-th GOP of the plurality of GOPs and transmitting the best time interval value to the displaying module, wherein the displaying module displays an (n+1)-th GOP using the best time interval; and
a dynamic compensation module connected to the displaying module for calculating a compensation time interval and transmitting the compensation time interval value to the displaying module, wherein the displaying module displays the frames of (n+2)-th to (n+2+m)-th GOPs subsequent to the (n+1)-th GOP using the compensation time interval to compensate a time error in the (n+1)-th GOP, and n is a positive integer and m is a natural number.

22. The system for improving video/audio data displaying fluency of claim 21, wherein the frame display time computation module further utilizes other GOPs to compute the best time interval and transmits it to the displaying module.

23. The system for improving video/audio data displaying fluency of claim 22, wherein the displaying module further uses the best time interval to display an (n+3+m)-th GOP, and uses a dynamic compensation process and an x number of GOPs to compensate a time error of the (n+3+m)-th GOP when the time error in the (n+3+m)-th GOP exceeds a predetermined error value; wherein x is a natural number.

24. The system for improving video/audio data displaying fluency of claim 23, wherein the displaying module further uses a best time interval of the (n+3+m)-th GOP to display an (n+4+m)-th GOP, and uses the dynamic compensation process and an y number of GOPs to compensate a time error of the (n+4+m)-th when the time error of the (n+4+m)-th GOP exceeds the predetermined error value; wherein y is a natural number.

25. The system for improving video/audio data displaying fluency of claim 21, wherein the computation of the best time interval basing on the n-th GOP refers to calculating a predicted time interval basing on frames of the n-th GOP; when the predicted time interval exceeds a specific range, a preset value is used as the best time interval, and if the predicted time interval does not exceed the specific range, the predicted time interval is used as the best time interval.

26. The system for improving video/audio data displaying fluency of claim 25, wherein the calculation of the predicted time interval basing on frames of the n-th GOP refers to calculating a time difference between start point of the n-th GOP and start point of the (n+1)-th GOP before dividing the time difference by the number of frames in the n-th GOP to obtain the predicted time interval.

27. The system for improving video/audio data displaying fluency of claim 25, wherein the specific range is a multiple of 0.1-1.9 of NTSC standard value.

28. The system for improving video/audio data displaying fluency of claim 25, wherein the specific range is a multiple of 0.1-1.9 of PAL standard value.

29. The system for improving video/audio data displaying fluency of claim 21, wherein the time error exists between the last frame of the (n+1)-th GOP and the start point of the (n+2)-th GOP.

30. The system for improving video/audio data displaying fluency of claim 29, wherein the displaying module uses the compensation time interval to display the frames of the (n+2)-th to (n+2+m)-th GOPs that are for compensating the time error when the time error exceeds the predetermined error value.

31. The system for improving video/audio data displaying fluency of claim 30, wherein the number of frames in the (n+2)-th to (n+2+m)-th GOPs that are for compensating the time error determines the compensation time interval.

32. The system for improving video/audio data displaying fluency of claim 30, wherein the predetermined error value falls in a range of a multiple of 0-120 of the best time interval.

33. The system for improving video/audio data displaying fluency of claim 22, wherein the compensation time interval falls in a range of a multiple of 0-5 of the best time interval.

34. A system for improving video/audio data displaying fluency, comprising:
a displaying module connected to a display screen for displaying a plurality of GOPs;
a frame display time computation module connected to the displaying module for computing a best time interval basing on an n-th GOP of the plurality of GOPs and transmitting the best time interval value to the displaying module for the displaying module to display frames of an (n+1)-th GOP subsequent to the n-th GOP, wherein the best time interval is computed by calculating a time difference between the start points of the n-th and the (n+1)-th GOPs before dividing the time difference by the number of frames in the n-th GOP to obtain a predicted time interval; when the predicted time interval exceeds a specific range, a preset value is used as the best time interval, and if the predicted time interval does not exceed the specific value, the predicted time interval is used as the best time interval; and
a dynamic compensation module connected to the displaying module for calculating a compensation time interval and transmitting the compensation time interval value to the displaying module, wherein when a time error existing between the last frame of the (n+1)-th GOP and start point of an (n+2)-th GOP exceeds a predetermined error value, the displaying module uses the compensation time interval to display the frames in the frames of the (n+2)-th to (n+2+m)-th GOPs that are for compensating the time error to compensate the time error; the number of frames in the (n+2)-th to (n+2+m)-th GOPs that are for compensating the time error determines the compensation time interval, and n is a positive integer and m is a natural number.

35. The system for improving video/audio data displaying fluency of claim 34, wherein the frame display time computation module further utilizes other GOPs to compute the best time interval and transmits the best time interval to the displaying module.

36. The system for improving video/audio data displaying fluency of claim 35, wherein the displaying module further uses the best time interval to display an (n+3+m)-th GOP, and uses a dynamic compensation process and an x number of GOPs to compensate a time error of the (n+3+m)-th GOP when the time error in the (n+3+m)-th GOP exceeds a predetermined error value; wherein x is a natural number.

37. The system for improving video/audio data displaying fluency of claim 36, wherein the displaying module further uses a best time interval of the (n+3+m)-th GOP to display an (n+4+m)-th GOP, and uses the dynamic compensation process and an y number of GOPs to compensate a time error of the (n+4+m)-th GOP when the time error of the (n+4+m)-th GOP exceeds the predetermined error value; wherein y is a natural number.

38. The system for improving video/audio data displaying fluency of claim 34, wherein the specific range is a multiple of 0.1-1.9 of NTSC standard value.

39. The system for improving video/audio data displaying fluency of claim 34, wherein the specific range is a multiple of 0.1-1.9 of PAL standard value.

40. The system for improving video/audio data displaying fluency of claim 34, wherein the predetermined error value falls in a range of a multiple of 0-120 of the best time interval.

41. The system for improving video/audio data displaying fluency of claim 34, wherein the compensation interval falls in a range of a multiple of 0-5 of the best time interval.
